(19) United States
(12) Patent Application Publication
(10) Pub. No.: US 2019/0012596 A1
(43) Pub. Date: Jan. 10, 2019

(54) DATA PROCESSING SYSTEM, METHOD, AND DEVICE

(71) Applicant: ALIBABA GROUP HOLDING LIMITED, George Town (KY)

(72) Inventors: Kun GAI, Beijing (CN); Xingya DAI, Beijing (CN); Zelin HU, Beijing (CN); Sui HUANG, Beijing (CN); Bochao LIU, Beijing (CN); Chengru SONG, Beijing (CN); Peng SUN, Beijing (CN); Zhi WANG, Beijing (CN); Yanghui YAN, Beijing (CN); Huimin YI, Beijing (CN); Yu ZHANG, Beijing (CN); Liqin ZHAO, Beijing (CN); Guorui ZHOU, Beijing (CN); Xiaoqiang ZHU, Beijing (CN)

(21) Appl. No.: 16/029,389

(22) Filed: Jul. 6, 2018

(30) Foreign Application Priority Data
Jul. 7, 2017 (CN) 201710552725.5

(51) Int. Cl. G06N 3/08; G06N 3/063

(52) U.S. Cl. CPC G06N 3/08; G06N 3/063

(57) ABSTRACT

The present disclosure provides a data processing system, method and device. The system includes a control component and a plurality of computing subcomponents coupled to the control component. The plurality of computing subcomponents respectively processes sample subsets of a sample data set under instruction of a processing procedure in the control component. For one of the plurality of computing subcomponents, at least one data element is configured to output the sample subsets of the sample data set in sequence to an embedding element based on the processing procedure in the control component. At least one embedding element is configured to receive a sample subset based on the processing procedure in the control component, map sample data in the sample subset to a multi-dimensional space based on a mapping parameter to obtain a multi-dimensional sample subset, and output the multi-dimensional sample subset to at least one backend element. The at least one backend element is configured to perform model training on the received multi-dimensional sample subset according to a model stored in the at least one backend element.

### CROSS-REFERENCE TO RELATED APPLICATION

This application is based upon and claims priority to Chinese Patent Application No. 201710552725.5, filed on Jul. 7, 2017, the disclosure of which is expressly incorporated herein by reference in its entirety.

### TECHNICAL FIELD

The present disclosure relates to the technical field of computers, and particularly to data processing systems, methods, and devices.

### BACKGROUND

Since 2010, deep learning has been widely applied from academic circles to industrial circles, and provides breakthrough solutions and desirable effects in fields such as image, voice, and natural language processing. Deep learning can make full use of a strong computing capability to solve end-to-end problems directly on mass data by building a complex non-linear model from cascades of multiple layers of neural networks.

Such deep learning frameworks that can achieve desirable effects often feature a small problem space and a continuous feature space, and the scale of parameters of a deep model is generally below 1 billion GB.

When a deep model has extremely high model complexity, however, the parameter scale is up to tens or even hundreds of billions, and samples used for training the model are tens of TB or even higher. Such data scale consumes a large number of computing resources, leading to low computing capability.

### SUMMARY

Embodiments of the present disclosure provide a data processing system, method and device, which can save computing resources and increase the computing power for mass sample data.

According to some embodiments of the present disclosure, there is provided a data processing system including a control component and a plurality of computing subcomponents coupled to the control component. At least one of the computing subcomponents includes at least one data element, at least one embedding element, and at least one backend element. The plurality of computing subcomponents respectively processes sample subsets of a sample data set under instruction of a processing procedure in the control component. For one of the plurality of computing subcomponents, the at least one data element is configured to output one or more sample subsets of the sample data set in sequence to the at least one embedding element based on the processing procedure in the control component. The at least one embedding element is configured to map sample data in the sample subset to a multi-dimensional space based on a mapping parameter to obtain a multi-dimensional sample subset, and to output the multi-dimensional sample subset to the at least one backend element. The at least one backend element is configured to perform model training on the multi-dimensional sample subset according to a model stored in the at least one backend element.

According to some embodiments of the present disclosure, there is provided a data processing method. The method includes coupling a control component to one or more computing subcomponents including at least one data element, at least one embedding element, and at least one backend element. The method also includes processing, by the one or more computing subcomponents, sample subsets of a sample data set under instruction of a processing procedure in the control component. The processing further includes outputting, by the at least one data element, one or more sample subsets of the sample data set in sequence to the at least one embedding element based on the processing procedure in the control component. The processing further includes mapping, by the at least one embedding element, sample data in the sample subset to a multi-dimensional space based on a mapping parameter to obtain a multi-dimensional sample subset, and outputting, by the at least one embedding element, the multi-dimensional sample subset to the at least one backend element. The processing further includes performing, by the at least one backend element, model training on the multi-dimensional sample subset according to a model stored in the at least one backend element.

According to some embodiments of the present disclosure, there is provided a data processing device including a memory and a processor. The memory is configured to store executable program code. The processor is configured to read the executable program code stored in the memory to perform a method as follows. A control component is coupled to one or more computing subcomponents comprising at least one data element, at least one embedding element, and at least one backend element. The one or more computing subcomponents process sample subsets of a sample data set under instruction of a processing procedure in the control component. The processing further includes outputting, by the at least one data element, one or more sample subsets of the sample data set in sequence to the at least one embedding element based on the processing procedure in the control component. The processing further includes mapping, by the at least one embedding element, sample data in the sample subset to a multi-dimensional space based on a mapping parameter to obtain a multi-dimensional sample subset, and outputting, by the at least one embedding element, the multi-dimensional sample subset to the at least one backend element. The processing further includes performing, by the at least one backend element, model training on the multi-dimensional sample subset according to a model stored in the at least one backend element.

According to some embodiments of the present disclosure, there is provided a non-transitory computer-readable storage medium storing a set of instructions that is executable by one or more processors of an electronic device to cause the electronic device to perform a method as follows. A control component is coupled to one or more computing subcomponents comprising at least one data element, at least one embedding element, and at least one backend element. The one or more computing subcomponents process sample subsets of a sample data set under instruction of a processing procedure in the control component. The processing further includes outputting, by the at least one data element, one or more sample subsets of the sample data set in sequence to the at least one embedding element based on the processing procedure in the control component. The processing further includes mapping, by the at least one embedding element, sample data in the sample subset to a multi-dimensional space based on a mapping parameter to obtain a multi-dimensional sample subset, and outputting, by the at least one embedding element, the multi-dimensional sample subset to the at least one backend element. The processing further includes performing, by the at least one backend element, model training on the multi-dimensional sample subset according to a model stored in the at least one backend element.

According to the data processing system, method, and device in some embodiments of the present disclosure, in the case of mass data and complex models, data parallel and model parallel may be used to increase the computing capability during data processing, thereby saving resources, reducing the power consumption, and obtaining a better effect of deep model learning of samples.

### BRIEF DESCRIPTION OF THE DRAWINGS

To describe the technical solutions in the embodiments of the present disclosure more clearly, the drawings to be used in the embodiments of the present disclosure are briefly introduced. Those of ordinary skill in the art may further obtain other drawings according to these drawings without creative efforts.

FIG. 1 is a schematic structural diagram of an exemplary data processing system according to some embodiments of the present disclosure;

FIG. 2 is a schematic structural diagram of an exemplary data processing system according to some embodiments of the present disclosure;

FIG. 3 is a flowchart of an exemplary data processing method according to some embodiments of the present disclosure; and

FIG. 4 is a structural diagram of an exemplary hardware architecture of a computing device capable of implementing the data processing system and method according to some embodiments of the present disclosure.

### DETAILED DESCRIPTION

Features and exemplary embodiments of various aspects of the present disclosure will be described in detail below. To make the objectives, technical solutions, and advantages of the present disclosure more comprehensible, the present disclosure is described below in further detail with reference to the accompanying drawings and embodiments. It should be understood that specific embodiments described here are used for explaining the present disclosure only, and are not intended to limit the present invention. For those skilled in the art, the present disclosure can be implemented without some of these specific details. The following description of embodiments is merely for the purpose of providing a better understanding of the present invention through examples of the present disclosure.

It should be noted that as used herein, the relational terms such as first and second are merely used for distinguishing one entity or operation from another, and do not necessarily indicate or imply any actual relationship or order between these entities or operations. In addition, the terms “include,” “comprise,” or any other variation thereof, are intended to cover a non-exclusive inclusion, such that a process, method, article, or device that includes a list of elements is not limited to include only those elements but may also include other elements not expressly listed or elements inherent to such process, method, article, or device. Provided that there are no further constraints, an element defined by “include . . . ” does not preclude the existence of additional identical elements in the process, method, article, or device that includes the element.

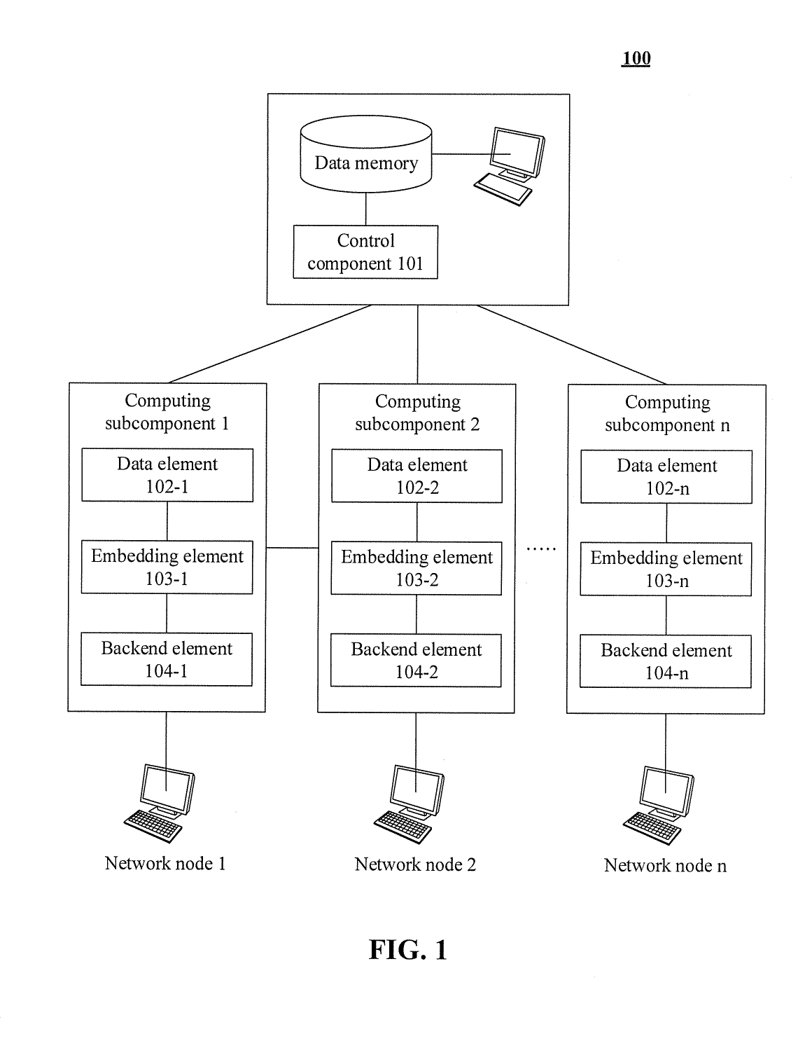

FIG. 1 is a schematic structural diagram of a data processing system according to some embodiments of the present disclosure. A data processing system 100 according to these embodiments of the present disclosure may include a control component 101 and a plurality of computing subcomponents coupled to control component 101. For example, a plurality of computing subcomponents can include a computing subcomponent 1, a computing subcomponent 2, . . . , and a computing subcomponent n, where n is an integer greater than 1. In addition, in the description of the embodiments of the present disclosure, the term “plurality” indicates more than one.

A computing subcomponent may include a data element, an embedding element, and a backend element. In the computing subcomponent, the data element may be coupled to the embedding element, and the embedding element may be coupled to the backend element.

Taking a computing subcomponent 1 as an example, computing subcomponent 1 includes a data element 102-1, an embedding element 103-1, and a backend element 104-1. In computing subcomponent 1, data element 102-1 is coupled to embedding element 103-1, and embedding element 103-1 is coupled to backend element 104-1.

In data processing system 100, a user may define a data processing procedure by using control component 101, and the plurality of computing subcomponents may jointly process mass data based on a set of user-defined processing procedures.

In these embodiments of the present disclosure, a data stream of a sample data set may be distributed to the plurality of computing subcomponents. According to the processing procedure defined in control component 101 by the user, computing subcomponent 1, computing subcomponent 2, . . . , and computing subcomponent n may each perform, for a sample subset in the sample set, model training by using a model stored in the backend element of the corresponding computing subcomponent.

Namely, a task of processing data in the sample data set may be distributed to the plurality of computing subcomponents. A processing task completed by each computing subcomponent may be part of the data processing task of the entire data processing system 100 on the sample data set.

In some examples, control component 101, as a control device of the entire data processing system 100, may be implemented using a terminal device, or it may be implemented using a cloud service. The user may locally or remotely access control component 101 and define a data processing procedure, so that, under instruction of the data processing procedure, the plurality of computing subcomponents coupled to control component 101 jointly completes the data processing task on the sample data set by using the functions of the data element, the embedding element, and the backend element in each computing subcomponent.

In some embodiments of the present disclosure, the computing subcomponents can have the same structure. Therefore, the data elements, the embedding elements, and the backend elements in the respective computing subcomponents can have the same working principles under the control of a set of user-defined processing procedures. A data processing system according to some embodiments of the present disclosure is described in detail through specific embodiments and with reference to at least one of the plurality of computing subcomponents.

Taking computing subcomponent 1 as an example, data element 102-1 in computing subcomponent 1 can provide functions such as sample storage, sample parsing, and sample data output.

In some embodiments, data element 102-1 may be connected to a data storage. The data storage can include one or more sample subsets of the sample data set. The sample subsets stored in the data storages of the plurality of computing subcomponents constitute a universal set of the sample data set.

In some embodiments, sample subsets of the sample data set may have the same size or different sizes.

As an example, if the sample size of a sample data set is 5 million, the sample size of each sample subset may be 1 million.

As another example, data processing system 100 may include a control component and five computing subcomponents coupled to the control component.

In some embodiments, a data storage may include two forms: a local storage and a distributed disk storage. The distributed disk storage is adapted to store and meet computation of samples on the scale of ten billion GB or more, and can economically and efficiently analyze and process mass sample data.

As an example, the distributed disk storage may provide various data processing services based on a distributed platform. For example, a distributed disk storage may support cross-cluster (equipment room) data sharing, Structured Query Language (SQL) data retrieval, and Message Passing Interface (MPI) data communication.

As an example, the data type of the sample data may be an image sample, voice sample, or Natural Language Processing (NLP) sample.

In some embodiments, after obtaining a sample subset from a data storage, a data element may provide sample parsing of sample data, and the sample data may be converted to a data structure of a designated type through sample parsing. As an example, sample parsing is performed on a data sample formed by page contents of a social networking website to carry out information extraction and information conversion of the page contents. The information extraction may be, for example, extracting image and sound resources from the page contents. The information conversion may be, for example, cleaning and converting the page contents into Extensible Markup Language (XML) data.

In some embodiments, the data storage may store sample subsets of different sample data sets. According to a processing procedure defined in control component 101 by the user, the data storage may send sample subsets of respective sample data sets to the embedding element or the backend element in sequence for subsequent processing.

In some embodiments, control component 101 may determine, according to an attribute of sample data in a sample subset, whether to output the sample subset to the embedding element or the backend element.

In some embodiments, if the sample data in a sample subset is linearly inseparable, the data element may output the sample subset to an embedding element under the control of control component 101. The embedding element may map the sample data in the sample subset to a multi-dimensional space based on a mapping parameter to obtain a multi-dimensional sample subset.

According to some embodiments of the present disclosure, under the control of the user-defined processing procedure, the embedding element may perform distributed data processing on the sample data set by implementing the functions of mapping the sample data in a sample subset to a multi-dimensional space, updating the mapping parameter, and synchronizing the mapping parameter between the embedding elements of the plurality of computing subcomponents.

In some embodiments, a mapping parameter may be a matrix. Based on the mapping parameter, the sample data in a sample subset may be mapped to a multi-dimensional space to obtain a multi-dimensional sample subset, and the obtained multi-dimensional sample subset may be output to the backend element. Mapping of the sample data to the multi-dimensional space can reduce the difficulty and complexity of subsequent data processing.

As an example, an initial value of the mapping parameter may be a random parameter or a parameter value set by the user according to experience.

In some embodiments, after outputting the obtained multi-dimensional sample subset to the backend element, the embedding element may receive a gradient vector having been obtained by the backend element from performing model training on the multi-dimensional sample subset. The embedding element may update the mapping parameter according to the gradient vector.

In these embodiments of the present disclosure, model training may be performed on the multi-dimensional sample subset by using a gradient descent algorithm to obtain a gradient of the multi-dimensional sample subset. The mapping parameter can be updated by using the gradient so as to make the training result of the multi-dimensional sample subset closer to a target value of training.

In some embodiments, the gradient is a vector, and may be referred to as a gradient vector. The gradient vector can indicate a direction for updating a mapping parameter during training of a multi-dimensional sample subset. Updating the mapping parameter according to the value of the gradient vector along the direction of the gradient vector can ensure that each time after model training is performed on the multi-dimensional sample subset, the result is closer to the target value of model training.

In some embodiments, the embedding elements in the plurality of computing subcomponents can communicate with each other, and can be configured to synchronize the mapping parameter of the multi-dimensional sample subset between the embedding elements in the plurality of computing subcomponents according to instruction of the processing procedure in the control component.

In these embodiments, the embedding elements in the plurality of computing subcomponents jointly constitute an embedding layer. At the embedding layer, a processing task completed by each computing subcomponent is part of a data processing task on the sample data set. By means of the embedding layer, the mapping parameter can be synchronized between the plurality of computing subcomponents to obtain a mapping parameter of the sample data set.

In these embodiments of the present disclosure, the plurality of computing subcomponents may jointly complete updating of the parameter of the sample data set. Specifically, the plurality of computing subcomponents may respectively process the sample subsets of the sample data set. Namely, each computing subcomponent uses a backend element to perform model training on a sample subset to obtain a gradient vector, and updates the mapping parameter of the sample subset according to the gradient vector, thus completing part of the updating of the mapping parameter of the sample data set.

In some embodiments, the embedding elements of the computing subcomponents synchronously update the mapping parameter of the sample subset under instruction of the processing procedure in the control component.

Specifically, the synchronous updating can be performed as follows. After the embedding element of the computing subcomponent updates the mapping parameter, the embedding elements of the plurality of computing subcomponents may establish communication with each other and synchronize the mapping parameter of the multi-dimensional sample subset under instruction of the processing procedure in the control component. After the synchronization of the mapping parameter is completed, the plurality of computing subcomponents may process a next sample data set.

In some embodiments, the embedding elements of the computing subcomponents asynchronously update the mapping parameter of the sample subset under instruction of the processing procedure in the control component.

Specifically, the asynchronous updating can be performed as follows. After the embedding element of the computing subcomponent updates the mapping parameter, the plurality of computing subcomponents does not synchronously update the mapping parameter of the multi-dimensional sample subset, and the data element of the computing subcomponent may acquire one or more sample subsets of the next sample data set from the connected data storage to perform subsequent data processing.

In some embodiments, under instruction of the processing procedure in the control component, the embedding elements of the computing subcomponents asynchronously update the mapping parameter of the sample subset as described above when a maximum clock interval between the plurality of computing subcomponents is less than a time threshold. The embedding elements synchronously update the mapping parameter of the sample subset as described above when the maximum clock interval between the plurality of computing subcomponents is equal to the time threshold.

In the above embodiments, the case where the data element in the computing subcomponent outputs, based on the processing procedure in the control component, the sample subsets of the sample data set in sequence to the embedding element for processing is described in detail.

In some embodiments, according to a data attribute of sample data in the sample data set, the data element in the computing subcomponent may output, based on the processing procedure in the control component, the sample subsets in the sample data set in sequence to the backend element for model training.

Namely, under instruction of the processing procedure in the control component, the data element in the computing subcomponent may determine, based on the data attribute of the sample data in the sample data set, to output the sample subsets of the sample data set to the backend element.

If the sample subsets of the sample data set are output to the backend element, the backend element may perform model training on the sample subsets according to a model stored in the backend element to obtain a gradient vector, and feed the gradient vector back to the embedding element.

If the sample subsets of the sample data set are output to the embedding element, according to the description of the above embodiments, the embedding element maps the sample subsets to a multi-dimensional space to obtain multi-dimensional sample subsets, and then outputs the multi-dimensional sample subsets to the backend element for subsequent processing.

According to some embodiments of the present disclosure, the backend element may provide various models for data processing of the sample data set. The models stored in the backend elements of the plurality of computing subcomponents may be the same or different.

In some embodiments, the models stored in the plurality of backend elements include a deep learning framework TensorFlow. TensorFlow can be widely applied to various deep machine learning fields such as speech recognition and image recognition. In addition, TensorFlow supports an object-oriented interpreted language Python and an object-oriented programming language C/C++.

As an example, in the backend element, the deep learning framework TensorFlow and the language Python may be combined to construct a model structure in the backend element.

According to some embodiments of the present disclosure, n computing subcomponents may be arranged on m devices, where n and m are both integers greater than or equal to 1, and n and m may or may not be equal. The devices having the computing subcomponents may be connected via a network. Therefore, a device having one or more computing subcomponents may be understood as a network node.

As an example, one computing subcomponent may be arranged on each designated device.

As an example, if a designated device has sufficient computing power, a plurality of computing subcomponents may be arranged on the device.

According to the description of the above embodiments, in the data processing system according to the embodiments, the plurality of computing subcomponents is coupled to the control component, and under instruction of the processing procedure in the control component, jointly completes data processing of a sample data set based on a set of processing procedures.

The data processing system of the embodiments of the present disclosure can increase the processing capability of the data processing system for mass data and complex models, and exhibits strong computing power in model training.

In some embodiments, the embedding elements in the plurality of computing subcomponents jointly constitute an embedding layer of data processing system 100 to implement distributed data processing of the sample data set. Therefore, data processing system 100 according to the embodiments can be used as a distributed deep learning computing framework to perform deep learning model training for mass data and complex models.

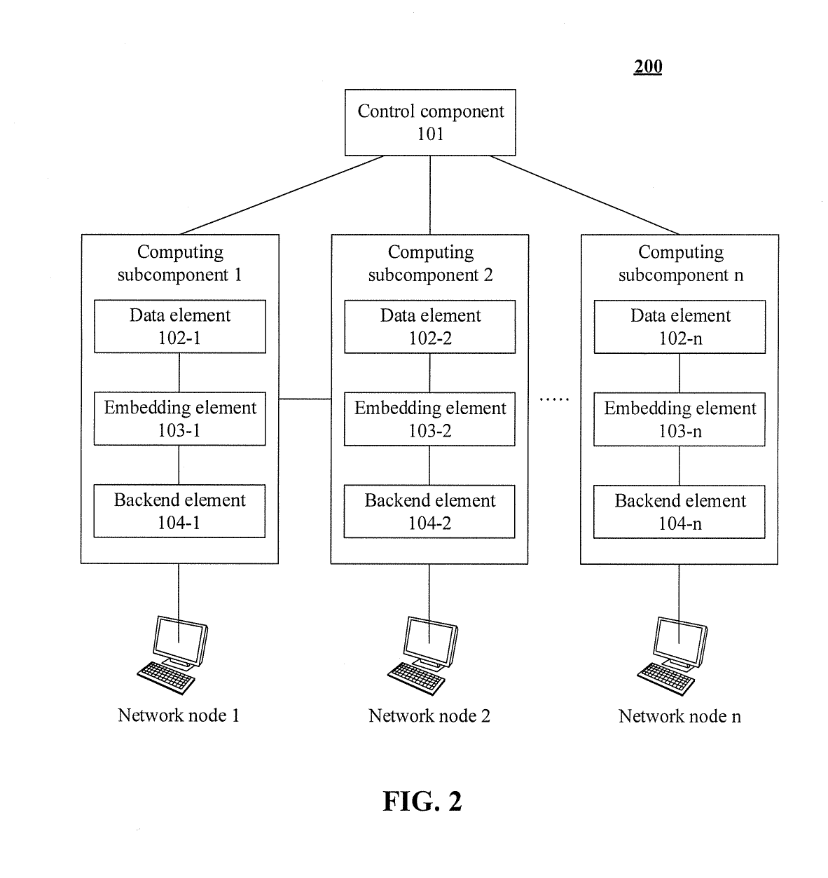

To provide a better understanding of the present disclosure, a data processing system according to some embodiments of the present disclosure is described in detail below through some exemplary embodiments and with reference to FIG. 2.

FIG. 2 is a schematic structural diagram of a data processing system according to some embodiments of the present disclosure. Structures in FIG. 2 that are the same as or equivalent to those in FIG. 1 are denoted by the same numerals.

In some embodiments, as shown in FIG. 2, a data processing system 200 may include a control component 101 and a plurality of computing subcomponents coupled to control component 101. For example, the plurality of computing subcomponents can include a computing subcomponent 1, a computing subcomponent 2, . . . , and a computing subcomponent n. The computing subcomponent includes one or more data elements, one or more embedding elements, and one or more backend elements.

For example, taking computing subcomponent 1 as an example, the plurality of computing subcomponents respectively processes sample subsets of a sample data set under instruction of a processing procedure in the control component. At least one of the plurality of computing subcomponents can include a data element 102-1, an embedding element 103-1, and a backend element 104-1. Data element 102-1 is configured to output the sample subsets of the sample data set in sequence to the embedding element based on the processing procedure in the control component. Embedding element 103-1 is configured to receive a sample subset based on the processing procedure in the control component, map sample data in the sample subset to a multi-dimensional space based on a mapping parameter to obtain a multi-dimensional sample subset, and output the multi-dimensional sample subset to the backend element. Backend element 104-1 is configured to receive the multi-dimensional sample subset and perform model training on the multi-dimensional sample subset according to a model stored in the backend element.

According to some embodiments of the present disclosure, the processing procedure in control component 101 may be user-defined.

In some embodiments, a user may define, in the processing procedure of control component 101 and according to a data attribute of the sample data set, whether the data element is to output the sample subsets of the sample data set to the embedding element or the backend element.

As an example, for one of the plurality of computing subcomponents and according to instruction of the processing procedure in control component 101, when the data element outputs the sample subsets of the sample data set in sequence to the embedding element for a number of times that reaches an output number threshold, the data element directly outputs the sample subsets of the sample data set in sequence to the backend element for model training.

As a specific example, for one of the plurality of computing subcomponents and according to instruction of the processing procedure in control component 101, when the number of times the data element outputs the sample subsets of the sample data set in sequence to the embedding element is less than 100, the data element may output the sample subsets of the sample data set in sequence to the embedding element. When the number of times the data element outputs the sample subsets of the sample data set in sequence to the embedding element exceeds 100, the data element may output the sample subsets of the sample data set in sequence to the backend element.

As an example, for one of the plurality of computing subcomponents and according to instruction of the processing procedure in control component 101, the data element outputs the sample subsets of the sample data set in sequence. When the number of times of outputting satisfies a first preset condition, the data element outputs, in sequence to the embedding element, the sample subsets of the sample data set corresponding to the number of times of outputting satisfying the first preset condition. When the number of times of outputting satisfies a second preset condition, the data element outputs, in sequence to the backend element, the sample subsets of the sample data set corresponding to the number of times of outputting satisfying the second preset condition.

As a specific example, for one of the plurality of computing subcomponents and according to instruction of the processing procedure in control component 101, the data element outputs the sample subsets of the sample data set in sequence. When the number of times of outputting is an odd number, the data element outputs, in sequence to the embedding element, the sample subsets of the sample data set corresponding to the odd number of times of outputting. When the number of times of outputting is an even number, the data element outputs, in sequence to the backend element, the sample subsets of the sample data set corresponding to the even number of times of outputting.

As an example, the user may define, in the processing procedure of control component 101, whether to synchronize the mapping parameter of the multi-dimensional sample subset between the embedding elements in the plurality of computing subcomponents after the embedding element receives the mapping parameter fed back by the backend element.

In some embodiments, the embedding elements in the plurality of computing subcomponents establish communication with each other. The plurality of computing subcomponents may synchronize the mapping parameter of the multi-dimensional sample subset between the embedding elements of the computing subcomponents according to instruction of the processing procedure in control component 101.

In some embodiments, the backend element is further configured to perform model training on the multi-dimensional sample subset to obtain a gradient vector, and feed the gradient vector back to the embedding element. The embedding element can be further configured to receive the gradient vector fed back by the backend element, and update the mapping parameter of the multi-dimensional sample subset according to the gradient vector.

In these embodiments of the present disclosure, the sample subsets of the sample data set processed by the plurality of computing subcomponents may constitute a universal set of the sample data set.

Accordingly, the plurality of computing subcomponents can obtain a mapping parameter of the sample data set by performing mapping parameter synchronization using the updated mapping parameter of the multi-dimensional sample subset through communication between the embedding elements in the plurality of computing subcomponents.

In these embodiments of the present disclosure, the models stored in the backend elements of the plurality of computing subcomponents may be the same or different.

In some embodiments, the model stored in the backend element includes a deep learning framework TensorFlow.

In some embodiments, for one of the plurality of computing subcomponents, the data element may be coupled to control component 101. Control component 101 may be coupled to the backend element.

As an example, the data format of the interface may be a preset matrix space.

In some embodiments, the matrix space occupies a preset fixed memory. During data processing, the size of the matrix space may remain unchanged.

The embodiments of the present disclosure provide a data processing system. In the data processing system, a plurality of computing subcomponents is coupled to control component 101, and may respectively perform data processing on sample subsets of a sample data set under instruction of a processing procedure in control component 101 to jointly complete model training of the sample data set. The data processing system has good overall optimization performance, and can make full use of and save computing resources, can reduce the power consumption, and can efficiently support computing of mass data and complex parameter models.

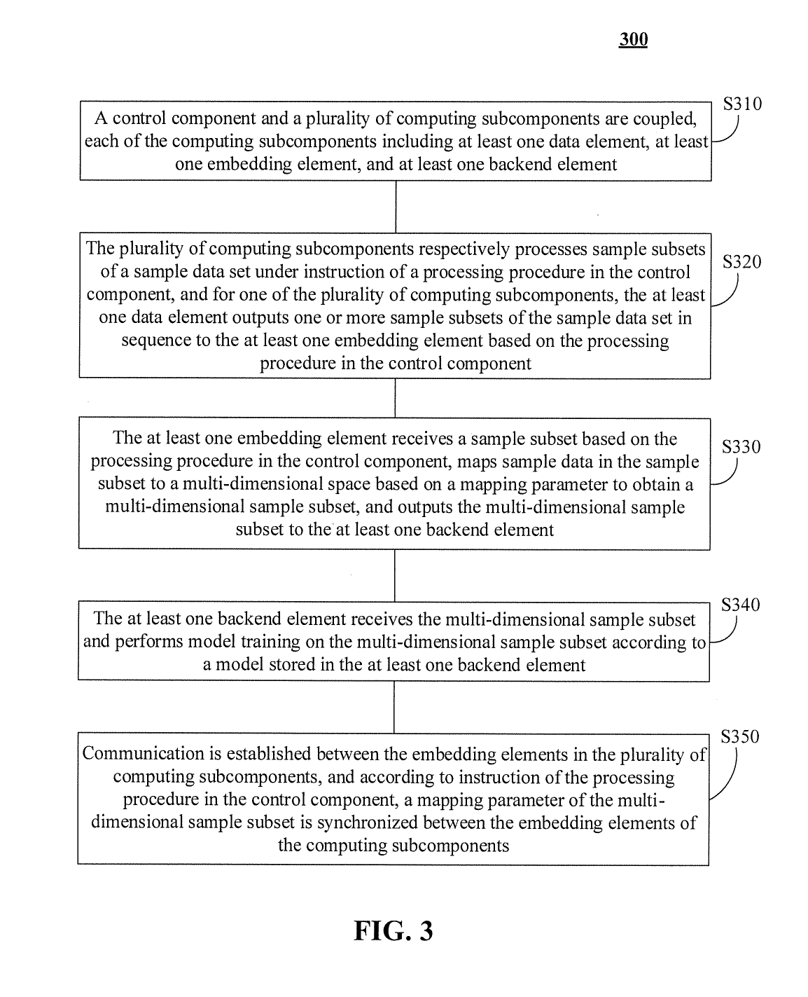

FIG. 3 is a flowchart of a data processing method according to some embodiments of the present disclosure. As shown in FIG. 3, a data processing method 300 in these embodiments of the present disclosure can include one or more of steps S310, S320, S330, and S340 as follows.

In step S310, a control component and a plurality of computing subcomponents are coupled. Each of the computing subcomponents includes one or more data elements, one or more embedding elements, and one or more backend elements. In this step, the control component is respectively coupled to the plurality of computing subcomponents. In a computing subcomponent, a data element may be coupled to an embedding element, and an embedding element may be coupled to a backend element.

In step S320, the plurality of computing subcomponents respectively processes sample subsets of a sample data set under the instruction of a processing procedure in the control component. For one of the plurality of computing subcomponents, the data element outputs one or more sample subsets of the sample data set in sequence to the embedding element based on the processing procedure in the control component. In these embodiments of the present disclosure, the sample subsets of the sample data set processed by the plurality of computing subcomponents constitute a universal set of the sample data set. Therefore, each computing subcomponent can complete part of a data processing task on the sample data set by processing one or more sample subsets of the sample data set. The plurality of computing subcomponents may jointly complete the data processing task on the sample data set under instruction of the processing procedure in the control component. In this step, the processing procedure in the control component may be a user-defined processing procedure.

In step S330, the embedding element receives a sample subset based on the processing procedure in the control component, maps sample data in the sample subset to a multi-dimensional space based on a mapping parameter to obtain a multi-dimensional sample subset, and outputs the multi-dimensional sample subset to the backend element. The sample data in the sample subset is mapped to a multi-dimensional space by using the mapping parameter to obtain a multi-dimensional sample subset, thereby reducing the complexity of subsequent data processing tasks. As an example, the mapping parameter may be a matrix, and an initial value of the mapping parameter may be a random parameter or it may be a user-defined parameter value.

In step S340, the backend element receives the multi-dimensional sample subset and performs model training on the multi-dimensional sample subset according to a model stored in the backend element. In some embodiments, the backend element stores various models, and the models stored in the backend elements of the plurality of computing subcomponents may be the same or different. Under instruction of the processing procedure in the control component, the backend element may select a suitable model to perform model training on the received sample subset, for example, the multi-dimensional sample subset.

In some embodiments, step S340 may specifically include step S341 and/or S342 as follows.

In step S341, the backend element receives the multi-dimensional sample subset, performs model training on the multi-dimensional sample subset according to a model stored in the backend element to obtain a gradient vector, and feeds back the gradient vector.

In step S342, the embedding element receives the gradient vector fed back by the backend element, and updates the mapping parameter of the multi-dimensional sample subset according to the gradient vector.

The models stored in the plurality of backend elements include a deep learning framework TensorFlow.

In these embodiments of the present disclosure, the backend element may feed the gradient vector back to the embedding element according to the instruction of the processing procedure in the control component after performing model training on the multi-dimensional sample subset.

As an example, according to the instruction of the processing procedure in the control component, the backend element may feed the gradient vector obtained through training back to the embedding element, after performing one time or other specified number of times of model training.

In some embodiments, the data processing method can further include a step S350 as follows. In step S350, communication is established between the embedding elements in the plurality of computing subcomponents, and according to instruction of the processing procedure in the control component, a mapping parameter of the multi-dimensional sample subset is synchronized between the embedding elements of the computing subcomponents.

In the data processing system according to the embodiments of the present disclosure, the embedding elements in the plurality of computing subcomponents jointly constitute an embedding layer of the data processing system to perform distributed processing of the data processing task on the data sample set.

In some embodiments, by synchronizing the mapping parameter of the multi-dimensional sample subset between the embedding elements of the computing subcomponents, a mapping parameter of the sample data set may be obtained. After this step, according to the instruction of the processing procedure in the control component, the sample subsets of the sample data set may be further processed, or the data processing according to the embodiments of the present invention may be performed on sample subsets of a next sample data set.

To provide a better understanding, the data processing method according to the embodiments of the present disclosure is illustrated through specific embodiments. It should be noted that data in the specific embodiments is only for the purpose of illustrating the work flow and principles of the data processing method, and should not be taken as a limitation to the data processing system and method of the embodiments of the present disclosure.

In the data processing method according to the embodiments of the present invention, for example, five computing subcomponents jointly perform the data processing on a sample data set. Each computing subcomponent may include a data element, an embedding element, and a backend element. A coupling relationship is established between the five computing subcomponents respectively and a control component.

For one of the five computing subcomponents, the data element reads or receives sample subsets of the sample data set from a local or cloud data storage. The sample data set includes, for example, 5 million samples, and the data storage connected to each data element may store, for example, 1 million samples.

The backend element receives the multi-dimensional sample subset, and performs model training on the multi-dimensional sample subset according to a model stored in the backend element.

Further, the backend element feeds back to the embedding element a gradient vector obtained by performing model training on the multi-dimensional sample subset, so that the embedding element can update the mapping parameter according to the gradient vector.

Under the instruction of the processing procedure in the control component, communication may be established between the embedding elements of the computing subcomponents. The mapping parameter of the multi-dimensional sample subset is synchronized through communication. A total mapping parameter corresponding to the sample data set may be obtained by exchanging the mapping parameter of the multi-dimensional sample subset between the embedding elements of the computing subcomponents.

The data processing method according to the embodiments of the present disclosure can still exhibit strong computing power when the sample size reaches tens of TB or even more and the parameter scale reaches the ten billion or even hundred billion level. The data processing method of the embodiments of the present disclosure can solve the problem of a large number of model parameters being unable to be loaded on a single device.

Other details of the data processing method according to the embodiments of the present disclosure are similar to those of the data processing system according to the embodiments of the present disclosure that are described with reference to FIG. 1 and FIG. 2, so the details will not repeatedly described herein.

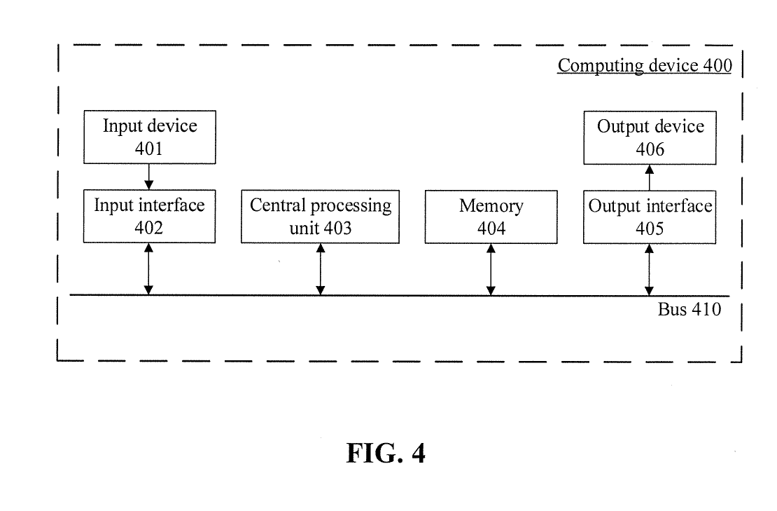

FIG. 4 is a structural diagram of an exemplary hardware architecture of a computing device capable of implementing the data processing system and method according to the embodiments of the present disclosure. As shown in FIG. 4, a computing device 400 includes an input device 401, an input interface 402, a central processing unit 403, a memory 404, the output interface 405, and an output device 406. Input interface 402, central processing unit 403, memory 404, and output interface 405 are connected to each other by a bus 410. Input device 401 and output device 406 are respectively connected to bus 410 through input interface 402 and output interface 405, and are thus connected to other components of computing device 300.

Specifically, input device 401 receives input information from the outside, and transfers the input information to central processing unit 403 through input interface 402. Central processing unit 403 processes the input information based on computer executable instructions stored in memory 404 to generate output information, temporarily or permanently stores the output information in memory 404, and then transfers the output information to output device 406 through output interface 405. Output device 406 outputs the output information to the outside of computing device 400 for use by a user.

Namely, the computing device shown in FIG. 4 may also be implemented as a data processing device. The data processing device may include: a memory storing computer executable instructions; and a processor, which can execute the computer executable instructions to implement the data processing system and method that are described with reference to FIG. 1 to FIG. 3. Here, the processor may communicate with an offline sample server, and execute the computer executable instructions based on relevant information from the offline sample server to implement the data processing system and method that are described with reference to FIG. 1 to FIG. 3.

The above embodiments may be completely or partially accomplished using software, hardware, firmware, or any combination thereof. When implemented using software, the embodiments may be completely or partially accomplished in the form of a computer program product or computer readable storage medium. The computer program product or the computer readable storage medium includes one or more computer instructions. When the computer program instructions are loaded and executed on a computer, some or all of the procedures or functions described in the embodiments of the present disclosure are generated. The computer may be a computer, a computer network, or other programmable devices. The computer instructions may be stored in a computer readable storage medium, or transmitted from one computer readable storage medium to another computer readable storage medium. For example, the computer instructions may be transmitted from one website, computer, server or data center to another website, computer, server or data center in a wired (for example, a coaxial cable, a fiber optic cable, a digital subscriber line (DSL), etc.) or wireless (for example, infrared, radio, microwave, etc.) manner. The computer readable storage medium may be any available medium that a computer can access or may be a data storage device integrating one or more available mediums, such as a server or a data center. The available medium may be a magnetic medium (for example, a floppy disk, a hard disk, a magnetic tape, etc.), an optical medium (for example, DVD), or a semiconductor medium (for example, a Solid State Disk (SSD)) and so on. The computer readable storage medium may be a non-transitory computer-readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

It should be noted that the present disclosure is not limited to the particular configurations and processing described above and shown in the figures. For the purpose of simplicity, detailed descriptions of known methods are omitted here. In the above embodiments, several specific steps are described and shown as examples. However, the method process of the present disclosure is not limited to the specific steps described and illustrated. It is appreciated that various changes, modifications, or additions or change the order of steps can be made after understanding the spirit of the present disclosure.

It should also be noted that the exemplary embodiments mentioned in the present disclosure describe some methods or systems based on a series of steps or devices. However, the present disclosure is not limited to the above order of steps. That is to say, the steps can be performed in the order mentioned in the embodiments or in an order different from that described in the embodiments, or several steps may be performed simultaneously.

The above descriptions are merely specific implementations of the present disclosure. Those skilled in the art should clearly understand that for the purpose of convenient description and brevity, the specific working processes of the system, modules and units described above can be referenced to the corresponding processes in the foregoing method embodiments and will not be described herein again. It should be understood that the protection scope of the present disclosure is not limited thereto, and those skilled in the art can easily figure out various equivalent modifications or replacements within the technical scope disclosed by the present disclosure. All such modifications or replacements shall fall within the protection scope of the present invention.

1. A data processing system, comprising:
a control component; and
a plurality of computing subcomponents coupled to the control component, wherein at least one of the plurality of computing subcomponents comprises at least one data element, at least one embedding element, and at least one backend element, and the plurality of computing subcomponents processes sample subsets of a sample data set under instruction of a processing procedure in the control component, and for the at least one of the plurality of computing subcomponents:
the at least one data element is configured to output one or more sample subsets of the sample data set in sequence to the at least one embedding element based on the processing procedure in the control component;
the at least one embedding element is configured to map sample data in the sample subset to a multi-dimensional space based on a mapping parameter to obtain a multi-dimensional sample subset, and to output the multi-dimensional sample subset to the at least one backend element; and
the at least one backend element is configured to perform model training on the multi-dimensional sample subset according to a model stored in the at least one backend element.

2. The data processing system according to claim 1, wherein the embedding elements in the plurality of computing subcomponents establish communication with each other, and are configured to:
synchronize a mapping parameter of the multi-dimensional sample subset between the embedding elements of the computing subcomponents according to instruction of the processing procedure in the control component.

3. The data processing system according to claim 1, wherein
the at least one backend element is further configured to perform model training on the multi-dimensional sample subset to obtain a gradient vector and to feed back the gradient vector; and
the at least one embedding element is further configured to receive the gradient vector fed back by the at least one backend element and to update the mapping parameter of the multi-dimensional sample subset according to the gradient vector.

4. The data processing system according to claim 1, wherein
the sample subsets of the sample data set processed by the plurality of computing subcomponents constitute a universal set of the sample data set.

5. The data processing system according to claim 1, wherein
the processing procedure in the control component is a user-defined processing procedure.

6. The data processing system according to claim 1, wherein
the model stored in the at least one backend element comprises a deep learning framework TensorFlow.

7. A data processing method, comprising:
coupling a control component to one or more computing subcomponents comprising at least one data element, at least one embedding element, and at least one backend element; and
processing, by the one or more computing subcomponents, sample subsets of a sample data set under instruction of a processing procedure in the control component, wherein the processing further comprises:
outputting, by the at least one data element, one or more sample subsets of the sample data set in sequence to the at least one embedding element based on the processing procedure in the control component;
mapping, by the at least one embedding element, sample data in the sample subset to a multi-dimensional space based on a mapping parameter to obtain a multi-dimensional sample subset;
outputting, by the at least one embedding element, the multi-dimensional sample subset to the at least one backend element; and
performing, by the at least one backend element, model training on the multi-dimensional sample subset according to a model stored in the at least one backend element.

8. The data processing method according to claim 7, further comprising:
establishing communication between the embedding elements in the plurality of computing subcomponents; and
synchronizing a mapping parameter of the multi-dimensional sample subset between the embedding elements of the computing subcomponents according to instruction of the processing procedure in the control component.

9. The data processing method according to claim 7, further comprising:
performing, by the at least one backend element, model training on the multi-dimensional sample subset to obtain a gradient vector, and feeding back the gradient vector; and
receiving, by the at least one embedding element, the gradient vector fed back by the at least one backend element, and updating the mapping parameter of the multi-dimensional sample subset according to the gradient vector.

10. The data processing method according to claim 7, wherein
the sample subsets of the sample data set processed by the plurality of computing subcomponents constitute a universal set of the sample data set.

11. The data processing method according to claim 7, wherein
the processing procedure in the control component is a user-defined processing procedure.

12. The data processing method according to claim 7, wherein
the model stored in the at least one backend element comprises the deep learning framework TensorFlow.

13-18. (canceled)

19. A non-transitory computer-readable storage medium storing a set of instructions that is executable by one or more processors of an electronic device to cause the electronic device to perform a method comprising:
coupling a control component to one or more computing subcomponents comprising at least one data element, at least one embedding element, and at least one backend element; and
processing, by the one or more computing subcomponents, sample subsets of a sample data set under instruction of a processing procedure in the control component, wherein the processing further comprises:
outputting, by the at least one data element, one or more sample subsets of the sample data set in sequence to the at least one embedding element based on the processing procedure in the control component;
mapping, by the at least one embedding element, sample data in the sample subset to a multi-dimensional space based on a mapping parameter to obtain a multi-dimensional sample subset;
outputting, by the at least one embedding element, the multi-dimensional sample subset to the at least one backend element; and
performing, by the at least one backend element, model training on the multi-dimensional sample subset according to a model stored in the at least one backend element.

20. The non-transitory computer-readable storage medium of claim 19, wherein the method further comprises:
establishing communication between the embedding elements in the plurality of computing subcomponents; and
synchronizing a mapping parameter of the multi-dimensional sample subset between the embedding elements of the computing subcomponents according to instruction of the processing procedure in the control component.

21. The non-transitory computer-readable storage medium of claim 19, wherein the method further comprises:
performing, by the at least one backend element, model training on the multi-dimensional sample subset to obtain a gradient vector, and feeding back the gradient vector; and
receiving, by the at least one embedding element, the gradient vector fed back by the backend element, and updating the mapping parameter of the multi-dimensional sample subset according to the gradient vector.

22. The non-transitory computer-readable storage medium of claim 19, wherein
the sample subsets of the sample data set processed by the plurality of computing subcomponents constitute a universal set of the sample data set.

23. The non-transitory computer-readable storage medium of claim 19, wherein
the processing procedure in the control component is a user-defined processing procedure.

24. The non-transitory computer-readable storage medium of claim 19, wherein
the model stored in the at least one backend element comprises the deep learning framework TensorFlow.
